(19) United States
(12) Patent Application Publication
(10) Pub. No.: US 2006/0245145 A1
(43) Pub. Date: Nov. 2, 2006

(54) Wireless communicating apparatus and production method therefor

(75) Inventors: Hidenori Wada, Anjo-city (JP); Hiromichi Naito, Okazaki-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/406,350

(22) Filed: Apr. 19, 2006

(30) Foreign Application Priority Data
Apr. 28, 2005 (JP) 2005-130724

(51) Int. Cl. H02B 1/00

(52) U.S. Cl. 361/600

(57) ABSTRACT

A wireless communicating apparatus includes a circuit board; a circuit component attached to the circuit board; a terminal provided to the circuit board for electrically linking the circuit component with an external apparatus for the circuit component and the external apparatus to communicate a signal; and a casing made of a resin-sealing material for directly covering a surface of the circuit component and a surface of the circuit board to which the circuit component is attached, while the casing includes a through-hole through which the terminal is exposed to an outside.

### CROSS REFERENCE TO RELATED APPLICATIONS

This application is based on and incorporates herein by reference Japanese Patent Application No. 2005-130724 filed on Apr. 28, 2005.

### FIELD OF THE INVENTION

The present invention relates to a wireless communicating apparatus that transmits and receives wireless signals and a production method for the wireless communicating apparatus.

### BACKGROUND OF THE INVENTION

A hand-held key used in Smart Key System (trademark) is a vehicular wireless communicating apparatus that transmits and receives wireless signals. This apparatus is typically available as a thin product such as a card type to reduce the size or enhance portability.

A card-type wireless communicating apparatus described in Patent Document 1 has a structure where circuit components such as an IC chip or antenna are mounted on a circuit board and the surface of the circuit components and this circuit board is directly covered by a resin-sealing material.

In this case, after the circuit and the circuit components are sealed by the resin, a property such as a signal-transmitting or signal-receiving property of the antenna sometimes varies to affect communication property of the wireless communicating apparatus. However, it is difficult to adjust the varied properties of the circuit components after the circuit components are sealed, which poses a problem.

Patent Document 1: JP-2005-179942 A (US2005136852 A1)

### SUMMARY OF THE INVENTION

It is an object of the present invention to provide a wireless communicating apparatus and a production method thereof to solve the above problem. With respect to the wireless communication apparatus, a property of its component can be inspected or adjusted even after the wireless communicating apparatus has been produced through resin-sealing.

To achieve the above object, a wireless communicating apparatus is provided with the following: a circuit board is included; a circuit component is attached to the circuit board; a terminal is provided to the circuit board for electrically linking the circuit component with an external apparatus for the circuit component and the external apparatus to communicate a signal; and a casing made of a resin-sealing material is included for directly covering a surface of the circuit component and a surface of the circuit board to which the circuit component is attached. Here, the casing includes a through-hole, through which the terminal is exposed to an outside.

Under the above structure, even after the circuit component and circuit board are sealed with resin, the though-hole allows the circuit component to be electrically linked with the external apparatus via the terminal. The circuit component is thus able to be adjusted after resin-sealing.

Furthermore, a production method of a wireless communicating apparatus is provided with the following steps: attaching a circuit component to a circuit board; providing a terminal to the circuit board for electrically linking the circuit component with an external apparatus for the circuit component and the external apparatus to communicate a signal; forming a casing using a resin-sealing material for directly covering a surface of the circuit component and a surface of the circuit board to which the circuit component is attached, wherein the casing is to include a through-hole through which the terminal is exposed to an outside; and inspecting the circuit component for adjustment as needed by electrically linking the terminal with the external apparatus so that the circuit component and the external apparatus communicate a signal after the step of forming the casing.

Under the above structure, after the circuit component and circuit board are sealed with resin, the circuit component can be electrically accessible by using the terminal and the though-hole. A varied property of the circuit component can be thus adjusted after resin-sealing.

### BRIEF DESCRIPTION OF THE DRAWINGS

The above and other objects, features, and advantages of the present invention will become more apparent from the following detailed description made with reference to the accompanying drawings. In the drawings:

FIG. 1 is a plan view of a wireless communicating apparatus according to a first embodiment of the present invention;

FIG. 2A is a plan view of a main part of the wireless communicating apparatus;

FIG. 2B is a plan view of an ornament member;

FIG. 3 is a sectional view taken from a line III to III in FIG. 2A;

FIG. 4 is a view illustrating a part of a production process for the wireless communicating apparatus;

FIG. 5 is a view illustrating a part of the production process to inspect and adjust a circuit component;

FIG. 6A is a plan view of an ornament member according to a second embodiment;

FIG. 6B is a plan view of an area close to terminals of a casing according to the second embodiment; and

FIG. 7A is a plan view of an ornament member according to a third embodiment; and

FIG. 7B is a plan view of an area close to terminals of a casing according to the third embodiment.

### DETAILED DESCRIPTION OF THE PREFERRED EMBODIMENTS

### First Embodiment

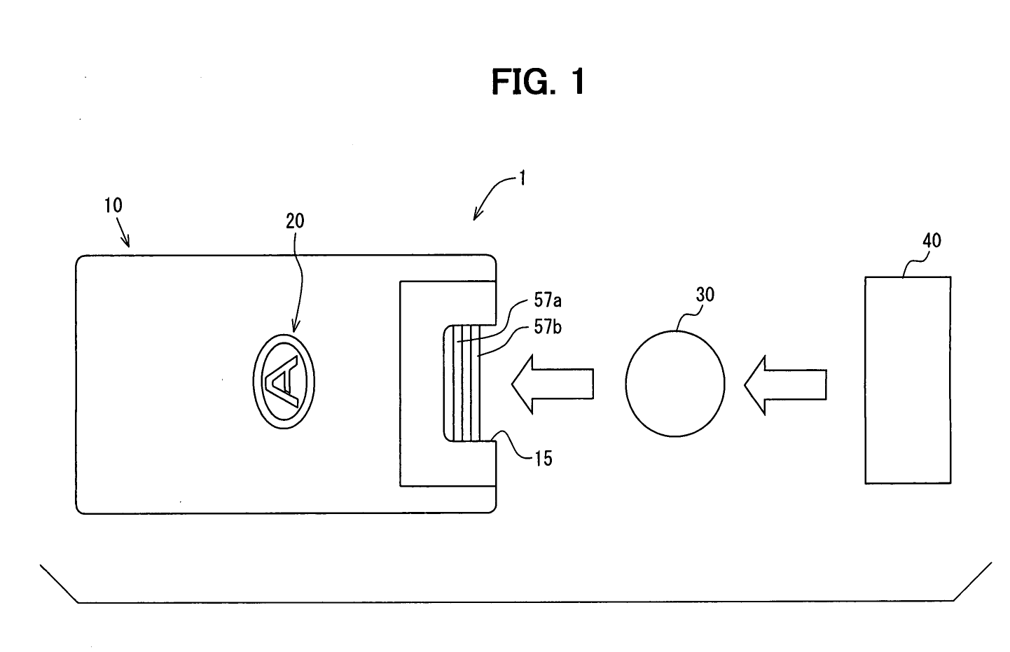

A wireless communicating apparatus according to a first embodiment of the present invention will be explained with reference to FIGS. 1 to 5 using an example of a hand-held key used for Smart Key System (trademark).

As shown in FIG. 1, a wireless communicating apparatus 1 that transmits and receives wireless signals includes a main body 10, a battery 30, and a cover plate 40.

The main body 10 has a battery container 15 for containing the battery 30, terminals 57a, 57b for supplying power of the battery 30 to the main body 10, and an ornament member 20. When the battery 30 is inserted into the battery container 15, the terminals 57a, 57b contact a positive side (front surface) and a negative side (rear surface) of the battery 30, respectively. The battery 30 is a typical disk-type button battery.

The ornament member 20 is a part of a design of the apparatus 1 and indicates a use to a user. For instance, when the apparatus 1 is used for a vehicle, the ornament member 20 has a brand mark of an automobile manufacturer or an automobile type. The user can distinguish the apparatus 1 from other cards having similar shapes such as a credit card, a bank card, etc.

The cover plate 40 protects the battery 30 contained in the battery container 15 or helps prevent the battery 30 from dropping off the battery container 15. The cover plate 40 is made of metal or resin to have a rectangular front surface and a U-shaped sectional view. When the cover plate 40 is attached to the main body 10 to hide the battery 30 and battery container 15, an edge line of the cover plate 40 and an edge line of the main body 10 forms one edge line or one side of the apparatus 1; thus, the apparatus 1 has an approximately rectangular planar card shape.

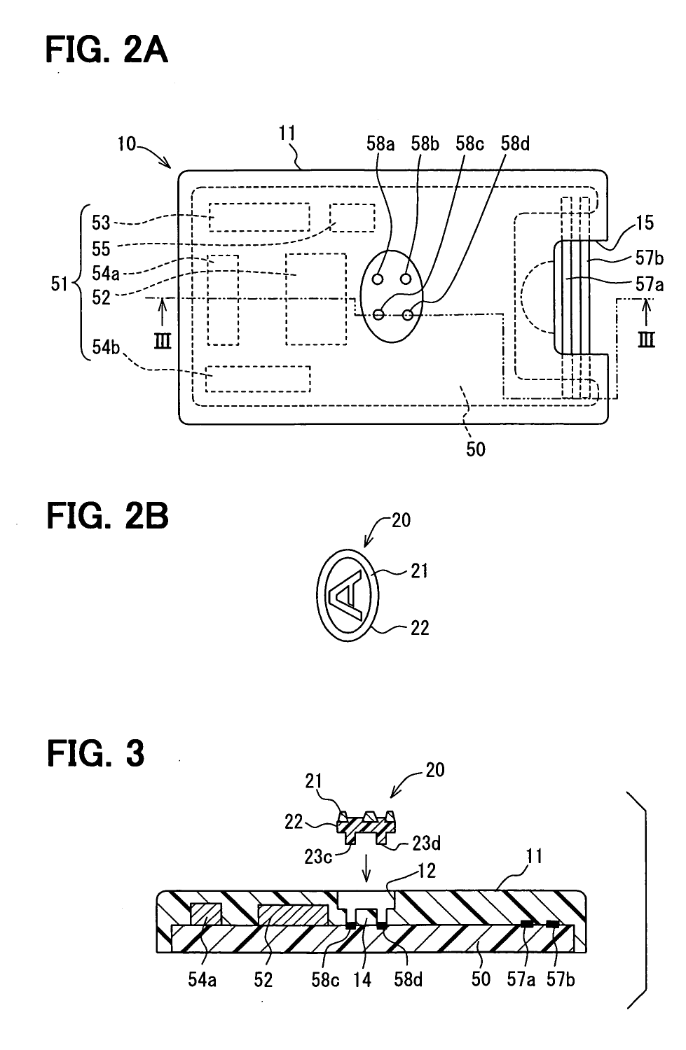

As shown in FIG. 2A, the main body 10 includes a circuit board 50, a circuit component group 51, the battery-use terminals 57a, 57b to be connected with the battery 30, external-use terminals 58a to 58d to be connected with an external apparatus, and a casing 11.

The circuit board 50 is a known printed-circuit board or flexible printed-circuit board or film. The circuit component group 51 is mounted on or attached to a surface of the circuit board 50. The circuit component group 51 is used to receive an ID request signal for requesting an ID code from a vehicle and to transmit a corresponding response signal to the vehicle.

The circuit component group 51 includes a transmission antenna 53, a reception antenna 54a, 54b, an IC package 52, and an electronic component 55. The circuit component group 51 is mounted on one (front) surface of the circuit board 50 in this embodiment, but it can be mounted on both (front and rear) surfaces. The antennas 53, 54a, 54b are formed of antenna coils wound around bobbins in this embodiment, but can be any other types to meet requirements in use of the apparatus 1.

The IC package 52 and the electronic component 55 control transmission of an ID code to the vehicle via the transmission antenna 53 based on the ID request signal received via the reception antenna 54a, 54b from the vehicle. The IC package 52 thus controls signal transmission and reception; furthermore, the IC package 52 stores the ID code and controls properties of the antennas 53, 54a, 54b such as output or frequency of radio waves.

The battery-use terminals 57a, 57b are formed of conductive material to be parallel with each other and connected with the circuit board 50 as shown in FIG. 2A. Furthermore, the terminals 57a, 57b are subjected to a bending process to properly contact the both surfaces of the battery 30 when the battery 30 is inserted to the battery container 15.

The external-use terminals 58a to 58d are provided in an approximately central portion of the surface of the circuit board 50 to be electrically linked with the IC package 52 via wiring lines formed on the circuit board 50. When an external apparatus (e.g., a computer) is linked with the terminals 58a to 58d, data stored in the IC package 52 can be updated, newly written, or read out, which will be explained later.

The casing 11 is made of resin-sealing material to directly cover the circuit board 50 and the circuit component group 51. Specifically, the casing 11 is formed by an insert molding process where the circuit board 50 and the circuit component group 51 mounted on the circuit board 50 are sealed with the resin-sealing material. The resin-sealing material can be thermoset resin. Furthermore, the casing 11 is formed to expose the battery-use terminals 57a, 57b and external-use terminals 58a to 58d to an outside.

A structure of the casing 11 will be further explained below with respect to an area close to the external-use terminals 58a to 58d using FIG. 3. After the casing 11 is formed with the insert molding process, a concave portion 12 is formed in the casing 11. The bottom of the concave portion 12 is connected with through-holes 13a to 13d, each of which allows each of the external-use terminals 58a to 58d, respectively, to be exposed to an outside. The shape and height (or depth) of the concave portion 12 approximately meet those of the ornament member 20 to allow the ornament member 20 to be inserted into the concave portion 12 with a proper dimensional tolerance.

A barrier member 14 is formed between the through-holes 13a to 13d to prevent a short-circuit between the terminals 58a to 58d if water enters any one of the through-holes 13a to 13d to reach a corresponding terminal 58a to 58d.

As shown in FIGS. 2B, 3, the ornament member 20 as a lid member is formed as a separate member from the casing 11. The ornament member 20 has an ornament 21 on its front surface, and protruding portions 23a to 23d corresponding to the through-holes 13a to 13d on its rear surface. In this embodiment, the ornament 21 has an oval brim and a mark of character “A” inside the brim. In a top view of the ornament member 20, the peripheral border line of the oval brim accords with a sidewall 22 of the ornament member 20. The ornament member 20 functions as a lid member and inserted into the concave portion 12 of the casing 11 to blank (or hide) and protect the external-use terminals 58a to 58d.

Production Method

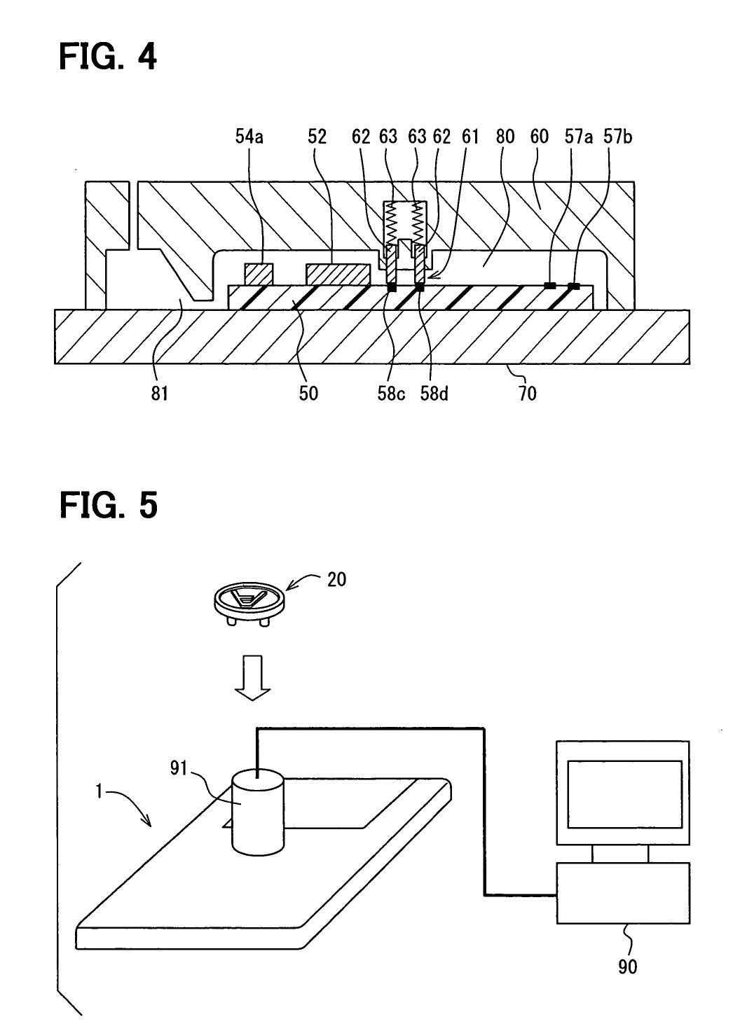

Next, a production method for the wireless communicating apparatus 1 will be explained with reference to FIGS. 4, 5. As an initial process, the circuit component group 51 is mounted in a specified placement of the circuit board 50; the battery-use terminals 57a, 57b are attached to the circuit board 50; and the external-use terminals 58a to 58d are provided to the circuit board 50. As shown in FIG. 4, the circuit board 50 is then interleaved between an upper metal mold 60 and a lower metal mold 70 to cause the rear surface of the circuit board 50 having no components or the like to face the lower metal mold 70. Furthermore, the circuit board 50 is vacuumed or sucked to the lower metal mold 70 to prevent the resin-sealing material from entering a possible gap between the circuit board 50 and lower metal mold 70. The upper metal mold 60 includes a protruding portion 61 that is used to form the concave portion 12, through-holes 13a to 13d, and barrier member 14. The tip end of the protruding portion 61 is designed to continuously contact the external-use terminals 58a to 58d during the insert molding process.

Specifically, the protruding portion 61 has movable pins 62 to form the through-holes 13a to 13d and individually move in the vertical direction in FIG. 3. The movable pins 62 are provided with springs 63, respectively, to bias the pins 62 to the circuit board 50. This causes the movable pins 62 to continuously contact the terminals 58a to 58d, preventing the resin-sealing material from entering a possible gap between the pins 62 and terminals 58a to 58d.

In the insert molding process, a thermoset resin of the resin-sealing material is pressure fed via a gate 81 into a cavity 80 formed between the upper and lower metal molds 60, 70 to directly contact and apply heat and pressure to the circuit component group 51. This may cause, in particular, antennas 53, 54a, 54b to vary their properties after the insert molding process.

In this embodiment, the casing 11 includes the concave portion 12 and through-holes 13a to 13d to expose the external-use terminals 58a to 58d, which are to be linked with the IC package 52 for adjusting the above varied properties after the insert molding process. As shown in FIG. 5, the terminals 58a to 58d are linked with a computer 90 as an external apparatus for adjustment.

Specifically, after the casing 11 is formed, a connector 91 connected with the computer 90 is inserted into the concave portion 12 and through-holes 13a to 13d; then, the computer 90 is operated to rewrite data in the IC package 52 to adjust the above properties. This allows inspection or adjustment of properties of the already sealed circuit component group 51 of the wireless communicating apparatus 1 that has been formed with the resin-sealing through the insert molding process.

Furthermore, since the computer 90 can be electrically linked with the IC package 52, an ID code previously stored in the IC package 52 can be inspected or an ID code can be newly written after the insert molding process. Furthermore, the computer 90 can read out data in the IC package 52, so that a failure diagnosis for the wireless communicating apparatus 1 can be realized.

The ornament member 20 is thereafter inserted and fastened to the concave portion 12, e.g., using an adhesive. This helps prevent removal of the ornament member 20 after adjustment or shipment of the apparatus 1. Furthermore, this helps prevent unconsidered change of states or conditions of the circuit component group 51 by connecting the terminals 58a to 58d with the computer 90.

In this embodiment, in a top view, the peripheral border line of the oval brim of the ornament member 20 accords with the sidewall 22 of the ornament member 20 or an internal wall of the concave portion 12 of the casing 11. This causes the user not to distinguish between a designed line and a physical boundary, helping prevent deterioration of the design of the wireless communicating apparatus 1.

Furthermore, if the ornament is provided to both a surface of the casing 11 and the ornament member 20, the boundary between the concave portion 12 of the casing 11 and the sidewall 22 of the ornament member 20 can be included in a design, which also helps prevent deterioration of the design of the wireless communicating apparatus 1.

### Other Embodiments

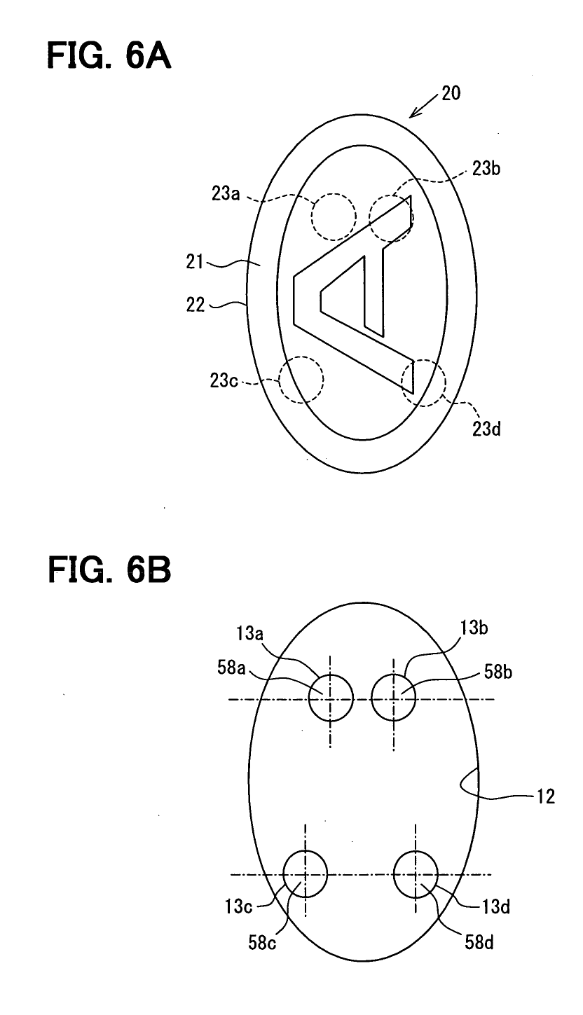

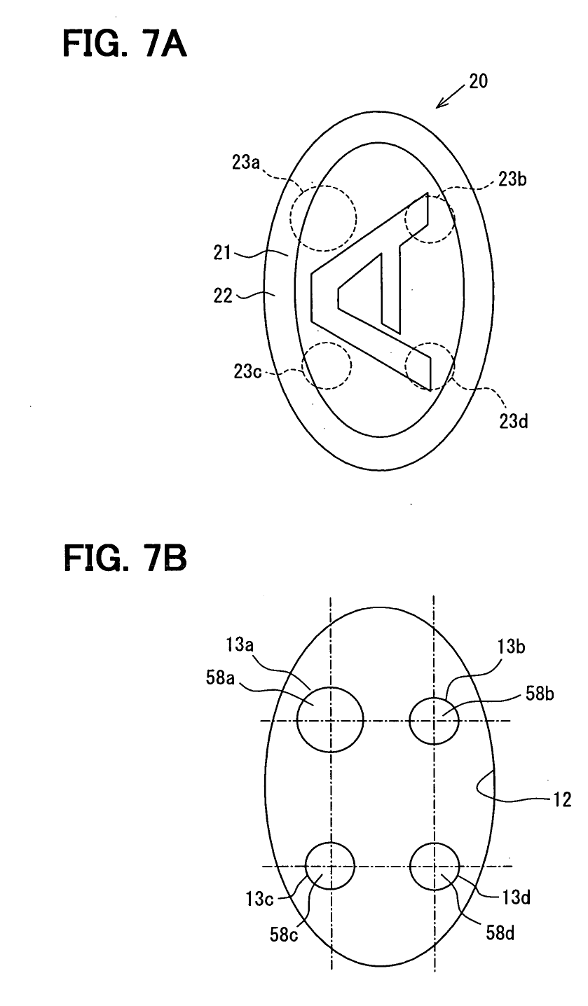

Wireless communicating apparatuses 1 according to a second embodiment and a third embodiment will be explained with reference to FIGS. 6A, 6B, 7A, 7B. In both the embodiments, a positional relationship (placement) or individual shapes of the through-holes 13a to 13d of the casing 11 is different from that of the first embodiment for preventing mis-assembly of the ornament member 20 to the casing 11. In other words, each of the protruding portions 23a to 23d is allowed to be inserted in a specific one of the through-holes 13a to 13d by defining (i) placement (or a positional relationship) of the plurality of through-holes 13a to 13d or (ii) individual shapes of the plurality of through-holes 13a to 13d.

As shown in FIGS. 6A, 6B, in the second embodiment, in a top view, the placement of the through-holes 13a to 13d has a trapezoidal shape; furthermore, the placement of the corresponding external-use terminals 58a to 58d of the circuit board 50 and the placement of the protruding portions 23a to 23d of the ornament member 20 have trapezoidal shapes different from that of the first embodiment. For instance, each of the protruding portions 23a to 23d is only inserted to a corresponding specific one of the through-holes 13a to 13d when the ornament member 20 can be inserted to the concave portion 12 of the casing 11. An orientation of the ornament member 20 is thus limited to one when being inserted or assembled into the concave portion 12 of the casing 11, i.e., the top of “A” must be left in FIG. 6A, preventing mis-assembly of the ornament member 20.

In contrast, as shown in FIGS. 7A, 7B, in the third embodiment, in a top view, the placement of the through-holes 13a to 13d has a rectangular shape similar to that of the first embodiment; however, the diameter of the through-hole 13a alone is different from (or larger than) those of others. Furthermore, the diameter of the protruding portion 23a alone of the ornament member 20 is different from (or larger than) those of the others. Thus, similarly to the second embodiment, an orientation of the ornament member 20 is limited to one when assembled, i.e., the top of “A” must be left in FIG. 6A, preventing mis-assembly of the ornament member 20.

It will be obvious to those skilled in the art that various changes may be made in the above-described embodiments of the present invention. However, the scope of the present invention should be determined by the following claims.

What is claimed is:

1. A wireless communicating apparatus comprising:
a circuit board;
a circuit component attached to the circuit board;
a terminal provided to the circuit board for electrically linking the circuit component with an external apparatus for the circuit component and the external apparatus to communicate a signal; and
a casing made of a resin-sealing material for directly covering a surface of the circuit component and a surface of the circuit board to which the circuit component is attached, wherein
the casing includes a through-hole, through which the terminal is exposed to an outside.

2. The wireless communicating apparatus of claim 1, further comprising:
a lid member for blanking the terminal.

3. The wireless communicating apparatus of claim 2, wherein
a surface of the lid member includes an ornament, and
a peripheral border line of the ornament accords with a boundary between the casing and the lid member attached to the casing.

4. The wireless communicating apparatus of claim 2, wherein
an ornament is provided on a surface of both the lid member and the casing,
a boundary line between the casing and the lid member attached to the casing accords with a line included in the ornament.

5. The wireless communicating apparatus of claim 1, further comprising:
a plurality of terminals including the terminal of claim 1, the plurality of terminals being provided to the circuit board, wherein
the casing includes a plurality of through-holes including the through-hole of claim 1, wherein each of the plurality of terminals corresponds to each of the plurality of through-holes and is exposed to the outside through the each of the plurality of through-holes, and
a barrier member is provided between in the plurality of the terminals.

6. The wireless communicating apparatus of claim 1, further comprising:
a plurality of terminals including the terminal of claim 1, the plurality of terminals being provided to the circuit board; and
a lid member for blanking the plurality of terminals, wherein
the casing includes a plurality of through-holes including the through-hole of claim 1, wherein each of the plurality of through-holes corresponds to each of the plurality of terminals and is exposed to the outside through the each of the through-holes, and
a plurality of protruding portions are provided to, of the lid member, a surface facing the circuit board, wherein each of the plurality of protruding portions is allowed to be inserted only in a specific one of the through-holes by defining at least one of (i) placement of the plurality of through-holes and (ii) individual shapes of the plurality of through-holes.

7. A production method for a wireless communicating apparatus, the production method comprising steps of:
attaching a circuit component to a circuit board;
providing a terminal to the circuit board for electrically linking the circuit component with an external apparatus;
forming a casing using a resin-sealing material for directly covering a surface of the circuit component and a surface of the circuit board to which the circuit component is attached, wherein the casing is to include a through-hole through which the terminal is exposed to an outside; and
linking the terminal with the external apparatus so that the circuit component and the external apparatus communicate a signal, after the step of forming the casing.

8. The production method of claim 7, further comprising a step of:
inspecting the circuit component or adjusting the circuit component after the step of linking the terminal.

9. The production method of claim 8, further comprising steps of:
attaching a lid member to the casing for blanking the terminal after the step of inspecting the circuit component or adjusting the circuit component; and
fastening the lid member to the casing.

10. The production method of claim 7, wherein
in the step of forming the casing, the casing is formed so that:
the circuit board is interleaved between a first metal mold and a second metal mold; and
the circuit board and the circuit component are subjected to an insert molding process,
the first metal mold includes a protruding portion corresponding to the through-hole, and
the protruding portion is moved to contact the terminal depending on a thickness of the circuit board.
